(19) United States
(12) Patent Application Publication
(10) Pub. No.: US 2010/0058907 A1
(43) Pub. Date: Mar. 11, 2010

(54) Apparatus for guiding and cutting web products and related methods

(75) Inventor: Peter Kern, St. Peter Port (GB)

Correspondence Address: WOOD, HERRON & EVANS, LLP, 2700 CAREW TOWER, 441 VINE STREET, CINCINNATI, OH, 45202, US

(73) Assignee: Kern International, Inc., Grove City, OH (US)

(21) Appl. No.: 12/231,739

(22) Filed: Sep. 5, 2008

(51) Int. Cl. B26D 7/06; B65B 43/26; D21F 11/00; D21F 1/36; B26D 1/00

(52) U.S. Cl. 83/86; 53/569; 162/202; 162/193; 162/286

(57) ABSTRACT

Guiding and cutting apparatus for use in a paper converting and sheet inserting apparatus. Guiding apparatus includes first and second rollers for engaging lateral edges of a web and a driving apparatus configured to permit the rollers to rotate at different surface speeds relative to one another. Cutting apparatus includes an angled blade for transversely cutting each side-by-side portion of a slit web into discrete sheets. Two side-by-side sheets are cut from respective web portions separately in time. Method, blade apparatus, web brake and slitter apparatus are disclosed.

### CROSS-REFERENCE

This application is generally related to the following co-pending U.S. patent application Ser. No. ______ (Attorney Docket No. KERI-06), entitled “Envelope Conveying and Positioning Apparatus and Related Methods;” Ser. No. ______ (Attorney Docket No. KERI-07), entitled “Inserting Apparatus for Discrete Objects into Envelopes and Related Methods;” Ser. No. ______ (Attorney Docket No. KERI-08), entitled “Transporting Apparatus for Discrete Sheets into Envelopes and Related Methods;” Ser. No. ______ (Attorney Docket No. KERI-09), entitled “Conveying Apparatus for Envelopes and Related Methods;” and Ser. No. ______ (Attorney Docket No. KERI-10), entitled “Transporting Apparatus for Web Products and Related Methods”, all being filed on even date herewith and expressly incorporated herein by reference in their entirety.

### TECHNICAL FIELD

The present invention generally relates to converting equipment and, more particularly, to apparatus for converting paper into sheets, collating and automatic envelope stuffing operations.

### BACKGROUND

Converting equipment is known for automatically stuffing envelopes. Such equipment may include components for feeding a pre-printed web of paper, for cutting such web into one or more discreet sheets for collating sheets, and for feeding such discreet sheet collations into envelopes. Such equipment may further include components to convey the stuffed envelopes to a specified location. The industry has long known apparatus which accomplish these and other functions. However, improvements are needed where high volumes of paper piece count and high speeds are required without sacrificing reliability accuracy and quality of end product.

More particularly, a large roll of paper is typically printed in discrete areas with piece specific information. That is, the initial roll of paper comprises vast numbers of discrete areas of already-printed indicia-specific information with each discrete area defining what is to eventually comprise a single page or sheet of indicia specific information. To complicate the process, a variable number of sheets with related indicia must be placed into the envelopes so that the content of one envelope varies from the content of another by sheet count and, of course, by the specific indicia on the included sheets. As one example, financial reports of multiple customers or account specifics may require a varied number of customer or account specific sheets to be cut, respectively collated, stuffed and discharged for delivery. Thus, the contents of each envelope include either a single sheet or a “collation” of from two to many sheets, each “collation” being specific to a mailing to an addressee.

In such an exemplary operation, a financial institution might send billing or invoice information to each of its customers. The billing information or “indicia” for one customer may require anywhere from one final sheet to a number of sheets which must be collated, then placed in that customer's envelope. While all this information can be printed in sheet size discrete areas, on a single roll, these areas must be well defined, cut, merged or collated into sheets for the same addressee or destination, placed into envelopes, treated and discharged. Thus, a system for conducting this process has in the past included certain typical components, such as a paper roll stand, drive, sheet cutter, merge unit, accumulate or collate unit, folder, envelope feeder, envelope inserter, and finishing and discharge units. Electronic controls are used to operate the system to correlate the functions so correct sheets are collated and placed in correct destination envelopes.

In such multi-component systems, the pass-through rate from paper roll to finished envelope is dependent on the speed of each component, and overall production speed is a function of the slowest or weakest link component. Overall reliability is similarly limited. Moreover, the mean down time from any malfunction or failure to repair is limited by the most repair-prone, most maintenance consumptive component. Such systems are capital intensive, requiring significant floor plan or footprint, and require significant labor, materials and maintenance capabilities and facilities.

In such a system, the process of guiding the web of material from the roll into or through a cutting station or module may present challenges. For example, and without limitation, conventional systems for guiding a web of material may not be configured to deal with skewing of the web.

In such systems, moreover, the process of cutting the web into discrete sheets may be limited in the attainable speeds of operation.

Accordingly, it is desirable to provide a guiding apparatus and a cutting apparatus and related methods that address some of the problems of conventional apparatus and methods.

It is similarly desirable to provide a converting apparatus in the form of an automatic envelope stuffing machine incorporating the guiding apparatus and cutting apparatus that address problems of conventional machines configured for automatically stuffing envelopes.

### SUMMARY

To these ends, in one particular embodiment of the invention, a cutting apparatus provides for longitudinally splitting then transversely cutting a web of paper or film traveling in a machine direction into discrete sheets. The transverse cutting apparatus includes a main blade supporting body, a first cutting blade that is coupled to a distal end of the main body and having a sharp edge for transversely cutting the web. A blade driving apparatus is coupled to the main body for controlling reciprocating motion of the first blade toward and away from the web. The main body is substantially made of a material that has a lower density relative to the first blade. For example, the first blade may include steel and/or the main body may be substantially made of carbon fiber.

Each reciprocating motion of the first blade from a home position and back to the home position may define a cutting cycle, with the blade driving apparatus being configured to drive the first blade at a rate of about 60,000 cycles per hour. The blade driving apparatus may include a motor and at least one rod that is operatively coupled thereto, with the rod being coupled to the main body to drive the first blade in reciprocating motion. A web driving apparatus for driving the web in the machine direction may cooperate with the blade driving apparatus to selectively stop the web at a predetermined position before the first blade cuts the web.

The web may be previously slit, in an embodiment not including the slitter, but in any event, the web is longitudinally slit in a direction extending generally along the machine direction thereby defining first and second lateral portions of the web, with the driving apparatus cooperating with the blade driving apparatus to move the first lateral portion in the machine direction while holding the second lateral portion stationary relative to the first lateral portion. The first blade may be angled in a direction transverse to the machine direction, such that one end is further spaced from a cutting position than the other. As the blade relatively moves, one lateral portion of the web is cut before the other as a result of this angle. Thus, one lateral area in one web portion is separated from its web portion prior to separation of the previously lateral area from its adjacent web portion. A second blade may be disposed opposite the first blade and cooperate with the first blade to effect a shear cut on the web. The first blade may include first and second edges for effecting first and second transverse cuts of the web spaced in the machine direction.

In another embodiment, a cutting apparatus is provided for cutting a web of paper or film traveling in a machine direction and includes a support frame and a web driving apparatus for moving the web in the machine direction. At least one slitting blade is supported in the support frame for slitting the web in the machine direction to thereby define at least first and second lateral portions of the web. The cutter apparatus is operatively coupled to a web driving apparatus for cutting the web in a direction transverse to the machine direction and including a main blade supporting body and a first blade coupled thereto, with the main body being substantially made of a material having a lower density relative to the blade itself. A driving apparatus is coupled to the main body for controlling reciprocating motion of the first blade toward and away from the web.

The cutting apparatus may include at least one edge slitting apparatus that is configured to engage a lateral edge of the web for trimming the lateral edge. The web driving apparatus may also include a brake that is moveable toward and away from the web, with movement toward the web being configured to momentarily disrupt travel of the web in the machine direction associated with transverse cutting of the web by the cutting apparatus. Such a brake may include a web-engaging brush. The web driving apparatus may be configured to move the brake away from the web during acceleration of the web in the machine direction. The brake may be oriented at an acute angle relative to the plane of travel of the web in the machine direction.

In this manner, cutting of discrete areas from a web and more particularly, from the adjacent web portion is improved. Flexibility and accuracy in downstream processes is improved, as well as reliability. The user is not captive to simultaneous cutting and transport of adjacent areas in each adjacent web portion. Throughput can be increased.

Such a cutter is particularly useful in a paper converting and envelope stuffing system contemplating improved paper converting and sheet inserting apparatus and methods, modular based, and having improved paper handling apparatus, servo driven for components, improved system sensor density and improved control concepts controlling the system operation. The invention contemplates the provision of an improved cutting apparatus which can be used as a module in a modular paper converting and sheet insertion system where human capital, required space, required equipment, maintenance, labor and materials and facilities therefore are reduced as compared to prior systems of similar throughput.

In another particular embodiment of the invention, a method is provided for guiding a web of paper or film traveling in a machine direction, with the web having opposed first and second lateral edges. The method includes engaging the first and second lateral edges respectively with first and second rollers disposed along an axis that is generally orthogonal to the machine direction. The first and second rollers are rotated to thereby move the web in the machine direction. The method includes allowing the first roller to rotate at a first surface speed that is different from a second surface speed associated with the second roller to accommodate web alignment and centering. The method may include rotating the first and second rollers from a common driver that is coupled to the first and second rollers. Engaging the first and second lateral edges may include frictionally engaging the first and second lateral edges respectively with the first and second rollers.

The method may include rotating the first and second rollers from a differential that is coupled to the first and second rollers. Engaging the first and second lateral edges may include engaging the first and second lateral edges with respective third and fourth rollers that are opposed and respectively cooperate with the first and second rollers to thereby nip the lateral edges of the web. The method may include sliding at least one of the third and four rollers to engage the lateral edges of the web.

In another embodiment, an apparatus is provided for guiding a web of paper or film traveling in a machine direction. The apparatus includes first and second rollers that are disposed along an axis that is generally orthogonal to the machine direction and configured for respectively engaging first and second opposed lateral edges of the web. The apparatus includes a driving apparatus that is coupled to the first and second rollers for rotating the first and second rollers, with rotation of the first and second rollers configured to move the web in the machine direction. The driving apparatus is configured to permit the first and second rollers to rotate at respective first and second surface speeds that are different from one another to accommodate guiding and centering of the moving web. The driving apparatus may be a differential. The first and second rollers may be configured to frictionally engage the web. The apparatus may include third and fourth rollers that respectively cooperate with the first and second rollers to nip the lateral edges of the web. At least one of the third or fourth rollers may be slidably movable respectively away from a corresponding one of the first or second rollers to permit disengagement of the at least one of the third or fourth rollers from the web. The driving apparatus may be disposed between the first and second rollers. Additionally or alternatively, coupling between the driving apparatus and the first roller may be such that the first roller can be made to rotate at the first surface speed by action of the web. The driving apparatus may include a generally flat surface for supporting a portion of the web.

In yet another embodiment, an apparatus is provided for guiding a web of paper or film traveling in a machine direction. The apparatus includes first and second rollers that are disposed along an axis generally orthogonal to the machine direction and configured for respectively engaging first and second opposed lateral edges of the web. The apparatus includes a differential operatively disposed and coupled to the first and second rollers for rotating the first and second rollers, with rotation of the first and second rollers being configured to move the web in the machine direction. The apparatus includes third and fourth rollers that respectively cooperate with the first and second rollers to nip the lateral edges of the web. The differential is configured to permit the web to align with the first and second rollers capable of rotating at respective first and second surface speeds that are different from one another.

In this manner, guiding of the web and more particularly, guiding of the web within a cutting station or module is improved. Flexibility and accuracy in downstream merger and collation is improved, as well as reliability and throughput can thus be increased.

Such a guiding apparatus is particularly useful in a paper converting and envelope stuffing system contemplating improved paper converting and sheet inserting apparatus and methods, modular based, and having improved paper handling apparatus, servo driven for components, improved system sensor density and improved control concepts controlling the system operation.

The invention contemplates the provision of an improved cutting apparatus having the described guiding apparatus and which can be used as a module of a modular paper converting and sheet insertion system where human capital, required space, required equipment, maintenance, labor and materials and facilities therefor are reduced as compared to prior systems of similar throughput.

In another particular embodiment of the invention. More specifically, such an improved apparatus and methods contemplate a plurality of functional modules providing the following functions in a series of modules of like or dissimilar modules where a specific module is multi-functional. The functions comprise:
printed paper roll handling/unwinding;
paper slitting and cutting;
sheet collation and accumulation;
sheet folding;
transportation for interfacing with inserts;
envelope feeding;
collation interfacing and insertion; and
envelope treating and discharge.

More particularly, one or more aspects of the invention may contemplate, without limitation, new and unique apparatus and methods for:
(a) guiding a web of the paper or film containing the printed indicia into a cutter apparatus;
(b) processing the web through slitting and transverse-cutting operation;
(c) transporting and merging discrete pieces of the insert;
(d) accumulating predefined stacks of discrete pieces of the insert;
(e) guiding and transporting a stack of discrete pieces of the insert toward an envelope-filling station;
(f) transporting individual envelopes toward the envelope-filling station;
(g) creating and processing a stack of the envelopes prior to the envelope-filling process; and
(h) processing an individual envelope from the stack of envelopes and through the envelope-filling station.

While the combination of the particular functions in the particular modules are unique combinations, the invention or this application lies primarily in the web guiding apparatus and methods described herein.

### BRIEF DESCRIPTION OF FIGURES

FIG. 1 is a perspective view illustrating a portion of a converter for stuffing envelopes with selected paper or film objects;

FIG. 2 is a perspective view of a cutting module of the converter of FIG. 1;

FIG. 3 is a perspective view of a leading portion of the cutting module of FIG. 2;

FIG. 4 is a cross-sectional view taken along line 4-4 of FIG. 3;

FIG. 5 is a perspective view of a portion of the cutting module processing a web of material therethrough;

FIG. 6 is a cross-sectional view of a transverse cutter of the module of FIG. 2;

FIG. 6A is a cross-sectional view similar to FIG. 4A showing a different embodiment of a transverse cutter;

FIG. 7A is a partially broken, end view of the transverse cutter of FIGS. 5-6;

FIG. 7B is a view similar to FIG. 7A, but showing the transverse cutter in a lowered cutting position, relative to a web, below its position shown in FIG. 7A;

FIG. 8 is a view similar to FIG. 3 showing an exemplary operation of the cutting module in more diagrammatic format;

FIG. 9 is a perspective view of a driving apparatus of the cutting module of FIG. 2;

FIG. 10 is a detailed view of a driver of the driving apparatus of FIG. 9;

FIG. 11A is a perspective view of a roller assembly of the driving apparatus of FIG. 9; and

FIG. 11B is a perspective view similar to FIG. 11A showing the roller assembly in a different position.

### DETAILED DESCRIPTION

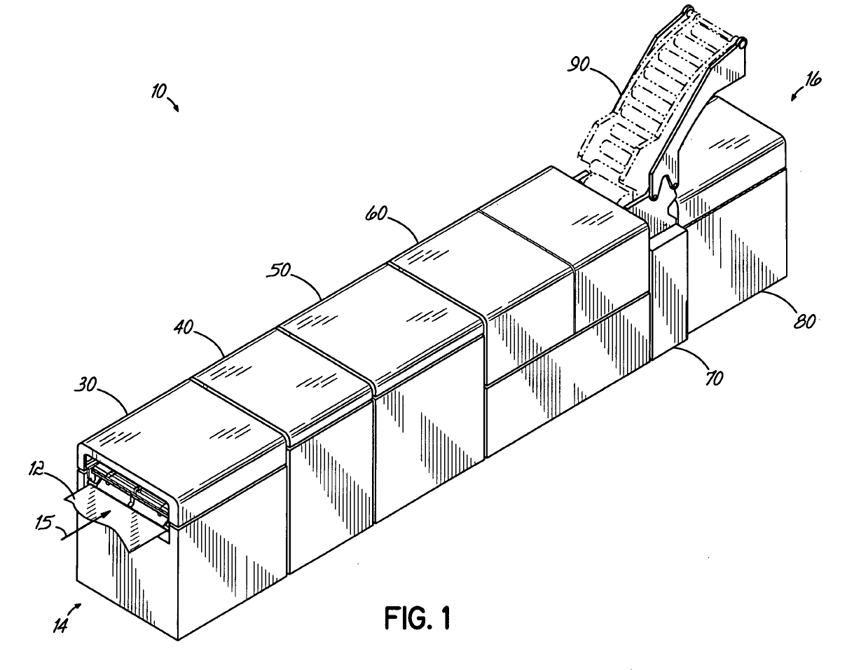

Referring to the figures and, more particularly to FIG. 1, a portion of an exemplary converter 1.0 is illustrated for processing a web 12 of paper or film. Although not shown, the web 12 processed by the converter 10 originates, for example, from a roll (not shown) of material containing such web. The roll is generally associated with a first end 14 of the converter 1 0 and is unwound in ways known in the art, for example, by driving a spindle receiving a core of the roll or by contacting a surface of the roll with a belt or similar apparatus. Typically, the web 12 is pre-printed with indicia in discrete areas.

The web 12 thus travels in a machine direction, generally indicated by arrow 15, through several modules that make up the converter 10. In the exemplary embodiment of FIG. 1, converter 10 cuts the web material into discrete sheets (corresponding to the “areas”) of material (“inserts”) and feeds them into envelopes fed generally from an opposite end 16 of converter 10. Converter 10 may further convey the envelopes containing the inserts away from the shown portion of the converter 10 for subsequent processing or disposition. The exemplary converter 10 includes, as noted above, several modules for effecting different steps in the processing of the web and the inserts resulting therefrom, as well as processing of the envelopes. Those of ordinary skill in the art will readily appreciate that converter 10 may include other modules in addition or instead of those shown herein.

A first of the shown modules, for example, is a cutting module 30 relatively proximate first end 14 of the converter 10 and which cuts the web 12 in ways to be described in further detail below. Cutting module 30 cuts the web into discrete inserts (not shown) for subsequent processing. A conveying module 40 controls and transports the discrete inserts received from the cutting module and feeds them into a folding and buffering module 50. Module 50 may, if necessary, form stacks of the discrete inserts for subsequent processing, for example, if the intended production requires stuffing the envelopes with inserts defined by more than one discreet sheet. Module 50 folds the discrete sheets, if required by the intended production, along a longitudinal axis of the discrete sheets disposed generally along the machine direction. Moreover, module 50 accumulates, collates or buffers sets of the discrete sheets into individually handled stacks, if the particular production so requires.

With continued reference to FIG. 1, an uptake module 60 takes the inserts from folding and buffering module 50 and cooperates with components of a stuffing module 70 to transport the inserts and feed them into envelopes. The envelopes, in turn, are handled and fed toward the stuffing module 70 by an envelope conveyor 80. A conveying assembly 90 is operatively coupled to the stuffing module 70 and the envelope conveyor 80 for conveying the stuffed or filled envelopes away from the shown portion of converter 10 for subsequent processing or disposition.

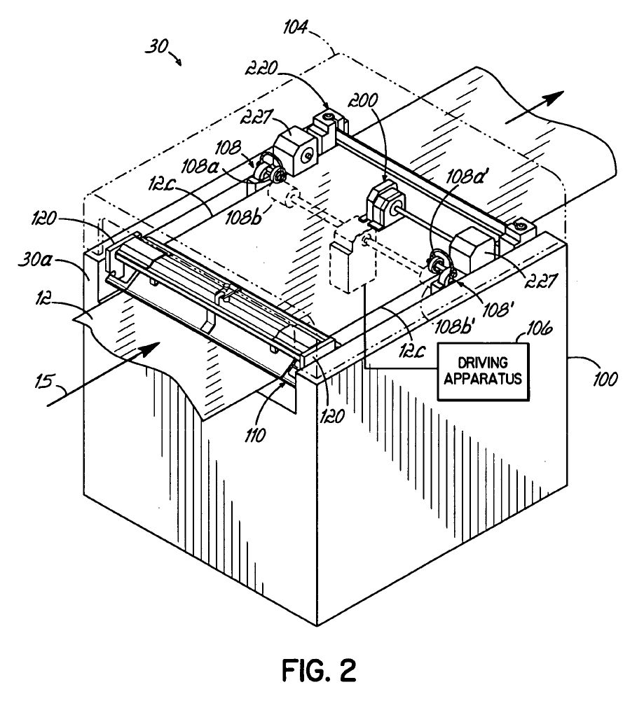

With reference to FIG. 2, an exemplary cutting module 30 is illustrated in greater detail. Module 30 includes a support frame or housing 100 that supports the different components of the module to be described in more detail below. Support frame 100 is in this embodiment made out of metal although other suitable materials may be chosen instead. A hood or cover 104, shown in phantom, restricts access to moving components of module 30 and may, for example, further protect the web from debris and the like. Hood or cover 104 may be made, for example, of a transparent or translucent material to permit viewing of the web and the moving components during operation.

Cutting module 30 includes a schematically depicted web driving apparatus 106 that may for example have a pair of roller assemblies 108, 108′ that frictionally engage lateral edges 12c of the web 12 and which rotate to thereby move the web 12 in the machine direction. In this exemplary embodiment, each roller assembly 108, 108′ includes an upper roller 108a, 108a′ and a cooperating lower roller 108b, 108b′ disposed opposite upper roller 108a, 108a′ and arranged to jointly nip a lateral edge of the web 12. Alternatively or additionally, web driving apparatus 106 may include movable components that engage perforations on the lateral edges 12c of the web 12 to positively engage web 12 and thereby move it in the machine direction. In this particular embodiment, web driving apparatus 106 has a web guiding feature that defines a guiding apparatus, the details of which are discussed below.

With particular reference to FIGS. 2-4, cutting module 30 includes, in addition to web driving apparatus 106, other components that guide web 12 therethrough. Thus, an infeed assembly 110 is positioned at a proximal end 30a of cutting module 30 for guiding and controlling movement of the web 12 in the machine direction (arrow 15). Handling of web 12 through cutting module 30 may be further facilitated by plates or guides (not shown) situated, for example, in lateral portions of the cutting module 30 and/or in the central portions thereof. Infeed assembly 110 is mounted onto support frame 100 via mounting blocks 120 suitably shaped and of suitable construction.

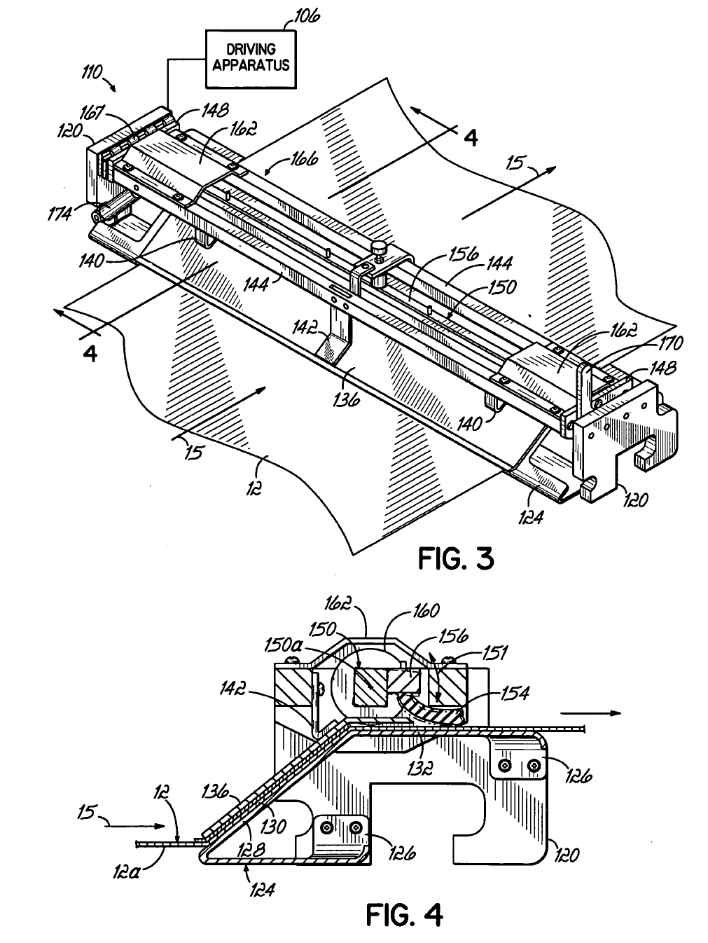

With particular reference to FIGS. 3-4, a guide plate 124 is disposed between the mounting blocks 120 and supported thereby by one or more brackets 126 in ways known in the art. Guide plate 124 supports an underside 12a of the web 12 and includes, to that end, a ramp portion 128 that defines an acute angle. For example, and without limitation, the angle may be about 45° relative to the general machine direction (arrow 15). Accordingly, the web 12 is guided to follow a first path 130 that similarly defines an angle of about 45° relative to the machine direction, and further relative to a second path 132 generally aligned with the machine direction. A complementary upper plate 136 made, for example, of a light material such as a plastic, is oriented similarly to ramp portion 128 and is disposed thereover thereby defining a gap between them that defines the first path 130.

Upper plate 136 prevents lifting of web 12 away from the intended path that may otherwise occur, for example, due to air trapped under web 12 during travel thereof. To this end, upper plate 136 is supported by lateral support brackets 140 and a center bracket 142 in turn supported by outer bars 144 coupled to the mounting blocks 120 through lateral mounting brackets 148.

A brake 150 extends between the lateral mounting brackets 148 and is pivotable about an axis 150a to selectively engage and disengage from the web 12, generally as indicated by arrow 151. To this end, pivotal motion of brake 150 is controlled by one or more components (not shown) of the schematically depicted web driving apparatus 106. In this regard, a brush 154 is coupled to a distal portion 156 of brake 150 to gently engage web 12. The bristles of brush 154 are suitably chosen to permit flexing of the bristles thereof such that webs of different thicknesses can be accommodated minimizing the risk of damaging the surface of web 12. For example, and without limitation, the brush 154 may include bristles made of nylon.

With continued particular reference to FIGS. 3-4, during use, and when desired, web driving apparatus 106 actuates brake 150 to cause brush 154 to engage and disrupt travel of web 12. A pair of driving rollers 160 (only one shown in FIG. 4), which engage and drive the web 12 in the machine direction, cooperates with brake 1 50 to further disrupt travel of the web 12. Specifically, driven rollers 160 of the web driving apparatus 106 may be selectively stopped generally contemporaneously with engaging actuation of brake 150 to thereby interrupt travel of the web 12 in the machine direction. When travel of web 12 is resumed, brake 150 is actuated in the opposite direction to thereby at least partially disengage brush 154 from the web 12. Notably, disengagement of brake 150 from web 12 during acceleration thereof minimizes the required power to get web 12 up to running speed.

It will be appreciated that the gentle engagement of the paper by the brush 1 54 serves to gently handle the paper web through its cycle of intermittent motion.

Moreover, it will be appreciated that various web handling rollers can be used to provide a web loop on one or both sides of the brake or cutter described herein to permit this intermittent motion of the web.

Access to driving rollers 160 is restricted by guards 162 supported by outer bars 144. Jointly, outer bars 144, brake 150, guards 162, and lateral mounting brackets 148 define a dynamic assembly 166 of infeed assembly 110. Notably, dynamic assembly 166 is pivotally or hingedly coupled, through a hinge 167 or similar, to one of the mounting blocks 120 to thereby permit full access to the web 12 for example, during maintenance or set-up of the operation prior to production. During operation, dynamic assembly 166 is locked in position by permitting engagement thereof with a locking apparatus such as one including a latch (not shown) located on the other of the mounting blocks 120. A lever 170 is coupled to the latch such that, when actuated, the dynamic assembly 166 may be decoupled from the second of mounting blocks 120. Movement of dynamic assembly 166 to the position shown in FIGS. 3-4 is facilitated by a dampening element in the form of a cylinder 174. More specifically, cylinder 174 restricts or slows down movement of dynamic assembly 166 between an open position (not shown) and the closed position shown in the figures. Accordingly, cylinder 174 prevents damage to module 30 otherwise caused, for example, by uncontrollably dropping dynamic assembly 166 toward the closed position.

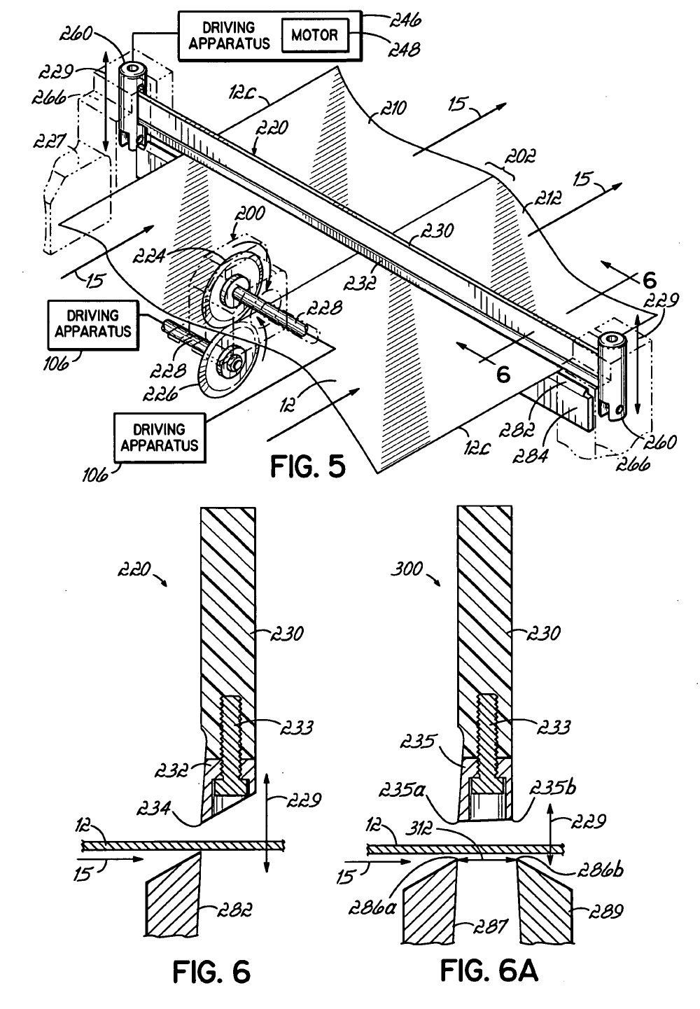

With reference to FIGS. 5-6, a cutting portion of the cutting module 30 is depicted therein. A center slitting apparatus 200 of the cutting module 30 cuts the web 12 generally along the machine direction and generally along a center portion 202 of the web 12. Alternatively, the lateral position of center slitting apparatus 200 could be adjusted such that the cut is effected at a location other than generally the center of web 12. Likewise alternatively, more than one slitting apparatus could be disposed in a main portion of the module to thereby slit the web at more than one lateral location. Cutting of the web 12 by center slitting apparatus 200 cuts the web 12 into first and second lateral portions 210, 212 such that a guillotine-type cutting apparatus 220 of module 30 can transversely cut the web 12 into at least two discrete sheets, as explained in further detail below.

Center slitting apparatus 200 includes upper and lower driven wheels 224, 226 driven by suitably chosen components of the web driving apparatus 106. For example, and without limitation, driven wheels 224, 226 my be driven by two spindles 228 coupled to a common shaft via a belt or similar component (not shown) of the web driving apparatus. Alternatively, driven wheels 224, 226 may be coupled to two different shafts of the web driving apparatus 106 and/or driven independently by separate servo motors. Each of driven wheels 224, 226 has a sharp edge cooperating with the other for engaging and cutting the web 12. In this regard, the driven wheels are disposed in close lateral proximity to one another to thereby cause a shear cut (i.e., a scissor-like cut) of the web 12.

While the exemplary slitting apparatus 200 of this embodiment includes two driven wheels 224, 226 as described, it is contemplated that it may instead include other types of cutting structures. For example, and without limitation, slitting apparatus 200 could instead have a single driven wheel and an anvil disposed opposite the single driven wheel. In this exemplary embodiment, moreover, an edge slitter 227 is disposed over a lateral edge 12c of web 12 to longitudinally trim lateral edge 12c. It is contemplated that cutting module 30 may alternatively include no edge slitters at all or include more than one edge slitter.

With continued reference to FIGS. 5-6, guillotine-type cutting apparatus 220 is positioned so as to effect a transverse cut on the portions of the now divided web 12. To this end, cutting apparatus 220 is disposed generally transversely to the machine direction (arrows 15) and is movable in reciprocating motion into engagement and disengagement relative to the web 12, as indicated by arrows 229. A generally rectangular main blade supporting body 230 of the cutting apparatus 220 supports a blade element 232 having a sharp edge 234 that cuts the web 12. A coupling between blade element 232 and main body 230 in this exemplary embodiment includes fasteners such as screws or bolts 233 that are threadably received within openings in main body 230. Notably, the type of coupling of this embodiment defines a releasable coupling between blade 232 and main body 230, which facilitates replacement of blade 232 when necessary.

The main body 230 in this exemplary embodiment is made of a material that is lighter (i.e., has a lower density) than the blade 232. In particular, for example and without limitation, the main body 230 may be substantially made of a carbon fiber. Likewise without limitation, the blade 232 may be substantially made of steel. The resulting relative light weight of the cutting apparatus 220 accordingly provides a low level of inertia to be present when the cutting apparatus is moved in reciprocating motion toward and away from the web 12. For example, the cutting apparatus 220 may be able to move at a speed of up to about 60,000 cycles per hour. As used herein, a cycle is defined as the motion of the blade 232 toward the web 12 from a home position (i.e., at its farthest away from the web) to a second position of full cutting engagement with the web, and back to the home position.

With continued reference to FIGS. 5-6, reciprocating motion of cutting apparatus 220 is facilitated by a blade driving apparatus 246 that is operatively coupled to main body 230 to thereby cause reciprocating motion thereof. In this embodiment, blade driving apparatus 246 includes a schematically depicted motor 248 coupled to rods 260 positioned proximate each lateral edge of cutting module 30. Rods 260 support the lateral edges of main body 230 and blade 232 and are movable vertically within respective lateral housings 266 of the cutting module 30 (shown in phantom).

In use, cutting apparatus 220 reciprocates toward and away from web 12 to effect a transverse cut, as discussed above. Moreover, in this particular embodiment, the transverse cut is facilitated by a second stationary (or reciprocal) blade 282 disposed opposite the blade 232. Second blade 282 is, in this embodiment, made of a single material, although it is contemplated that may alternatively have a structure similar to blade 232. Moreover, second blade 282 is, in this embodiment, stationary. Second blade 282 is closely positioned relative to blade 232 so as to jointly effect a shear transverse cut of the web 12. It is contemplated that, alternatively, cutting apparatus 220 may include a structure other than second blade 282. For example, cutting apparatus 220 may include a second blade that is movable in reciprocating motion in a fashion similar to blade 232, rather than being stationary. Likewise it is contemplated that cutting apparatus 220 may alternatively include no second blade at all or include an anvil or similar structure.

With reference to FIG. 6A, in which like reference numerals refer to like features in FIG. 6, an alternative embodiment of a cutting apparatus 300 is similar to cutting apparatus 220 but includes a blade 235 having two sharp cutting edges 235a, 235b that are spaced from one another, in the machine direction, to define a cutting distance 312 therebetween. For example, and without limitation, the cutting distance 312 may be about 5mm or some other distance. Accordingly, reciprocating movement of main body 230, for example, causes simultaneous engagement of both cutting edges 235a, 235b with corresponding sharp edges 286a, 286b of third and fourth blades 287, 289 that are also spaced in the machine direction by a gap substantially close to the cutting distance 312 defined above. Engagement of cutting edges 235a, 235b and blades 287, 289 with the web 12 effects two transverse cuts thereon, resulting in the cutting of a strip of web between succeeding areas or sheets.

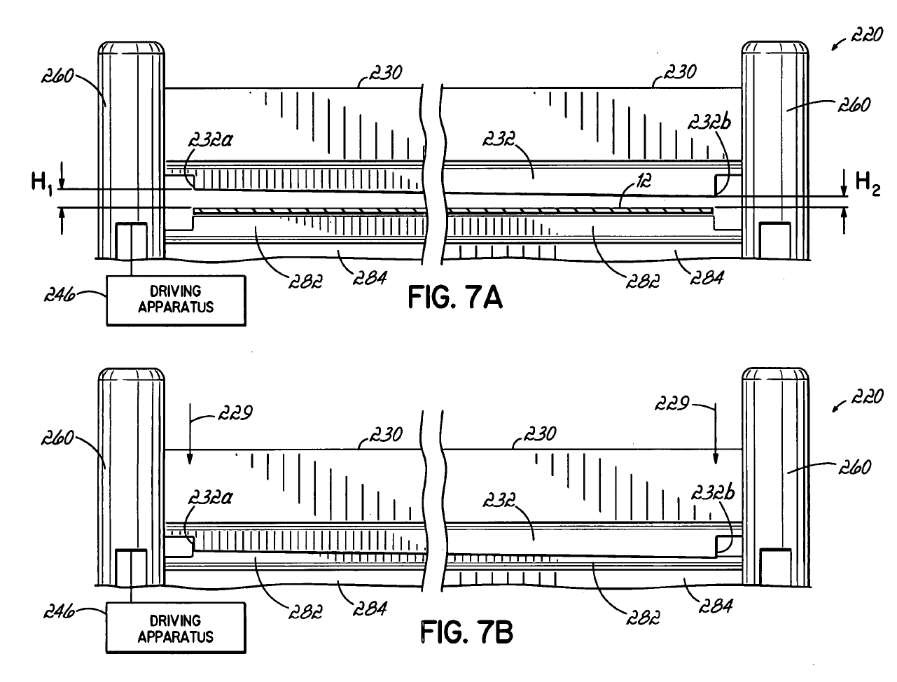

With reference to FIGS. 7A-7B, in one aspect of this exemplary embodiment, blade 232 is angled above and in a direction transverse to the machine direction (FIG. 5). More particularly, and for illustration purposes, blade 232 is angled such as to define a first vertical distance H₁ between a first lateral end 232a of blade 232 and a confronting end of second blade 282, and a second vertical, smaller distance H₂ at the second lateral end 232b. As illustrated herein, distances H₁ and H₂ correspond to a position of cutting apparatus 220 wherein it is disengaged from web 12. They may, for example, correspond to the home position of cutting apparatus 220, as defined above.

With particular reference to FIG. 7A, when cutting apparatus 220 moves into engagement with web 12 (in the direction of arrows 229), the overlap of blade 232 with second blade 282 is accordingly greater at the second lateral end 232b relative to the first lateral end 232a. While this embodiment shows second blade 282 being generally parallel to the plane of the web i.e., not angled in a direction transverse to the machine direction, it is contemplated that second blade 282 may alternatively be angled in such direction so long as the respective angle thereof cooperates with the geometry of blade 232 to thereby effect the transverse cut of the web 12.

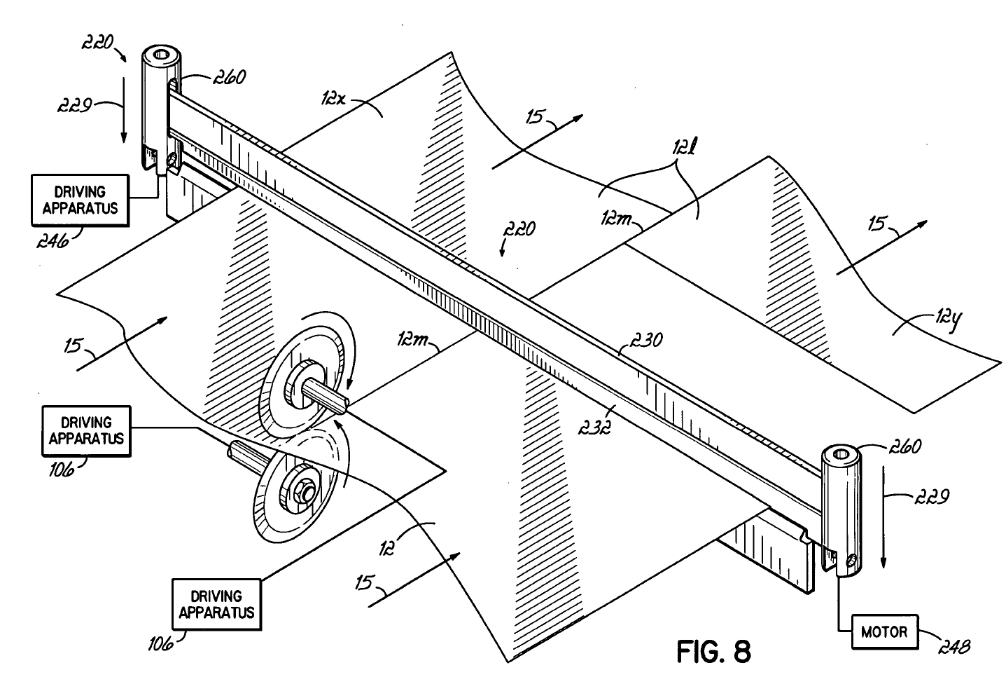

With reference to FIG. 8, an exemplary use of the cutting apparatus 220 is illustrated. Web driving apparatus 106 drives the web 12 in the machine direction (arrows 15) and, more particularly, moves a leading portion 12L of adjacent web portions 12 past cutting apparatus 220. The web driving apparatus 106, as explained above may actuate the brake 150 and stop rotating rollers 160 to thereby momentarily stop movement of the web 12 in the machine direction. Leading portion 12L is pre-slit along line 12m thereby defining left and right lateral portions 12X, 12Y of web 12.

As the cutting apparatus 220 and, more particularly, the main body 230 and blade 232 thereof move into engagement with stopped web 12 (arrows 229), the angled orientation of blade 232 permits cutting the right portion 12Y of web 12 before the left portion 12X is completely cut. Accordingly, cooperating rollers or other driving components (not shown) of the web driving apparatus 106 that are in engagement with leading portion 12L, move the right portion 12Y of the web while the left portion 12X remains in place i.e., stationary relative to right portion 12Y.

The blade driving apparatus 246, in this regard, optionally facilitates this exemplary operation by stopping vertical movement of the blade at the point shown in FIG. 8 i.e., such that it has not completely engaged the entire width of the web 12. Subsequent to forward movement of the right portion 12Y, and at a selected time, the blade driving apparatus 246 restarts or continues downward movement of the blade 232 towards the web 12, thereby cutting the left portion 12X. It is contemplated that the blade driving apparatus 246 may instead decelerate downward movement of the blade 232 toward the web rather than stopping such movement and thereby result in the same partial cutting of web 12 as described above.

Notably, this type of operation may be desirable, for example, when the intended insert consists of an odd number of discreet sheets. For example, the intended insert for a given envelope may only require one of the two discreet sheets respectively corresponding to the left and right portions 12X, 12Y. More specifically, with reference to the exemplary web 12, the left portion 12X becomes a first discreet sheet and the right portion becomes a second discreet sheet. In this regard, the exemplary operation of FIG. 8 permits processing i.e., stuffing thereof into an envelope, of the discreet sheet corresponding to the right portion 12Y, while the left portion 12X is held in place for subsequent stuffing into a different envelope.

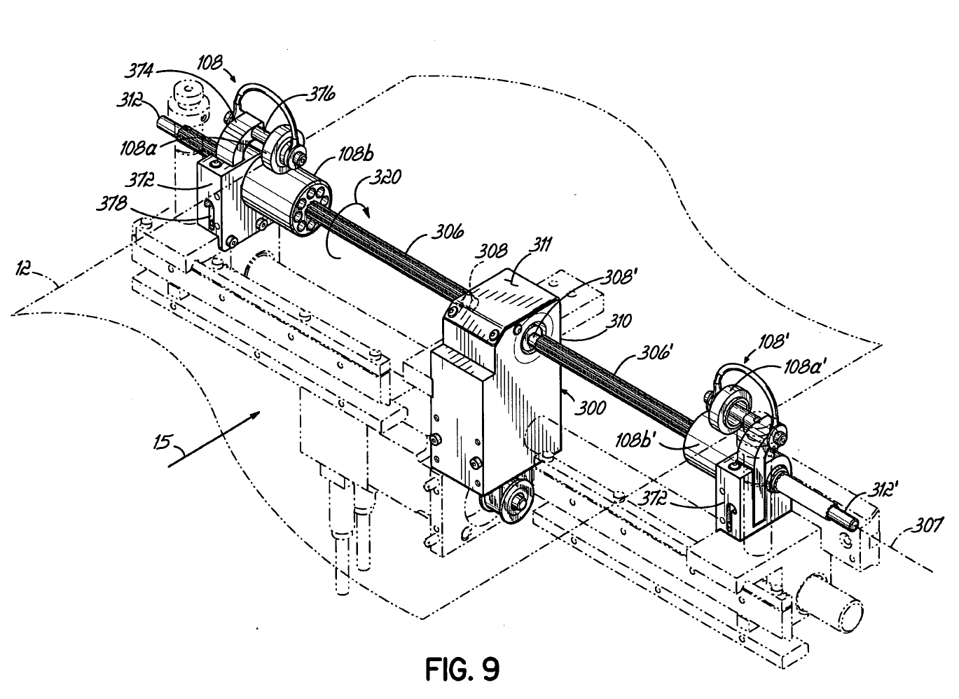

With reference to FIGS. 9, 10, 11A, and 11B, exemplary details of the web driving apparatus 106 are provided. As discussed above, web driving apparatus 106 defines a guiding apparatus that guides the web 12 through the cutting apparatus. To this end, the roller assemblies 108, 108′ are coupled to a common driver of the web driving apparatus 106 that drives roller assemblies 108, 108′ while permitting them to rotate at different surface speeds. More particularly, the lower rollers 108b, 108b′ of roller assemblies 108, 108′ are coupled to a common driver in the form of a differential 300, the operation of which is described in further detail below.

Differential 300 is coupled to each of the lower rollers 108b, 108b′ through respective shafts 306, 306′ extending along an axis 307 generally orthogonal to the machine direction (arrow 15) and having respective proximate ends 308, 308′ supported within a housing 310 of the differential 300. Housing 310 includes a generally flat surface 311 for supporting a central portion of the web 12. Shafts 306, 306′ also include distal ends 312, 312′ that are coupled to supporting frame 100 through respective bearings (not shown). Accordingly, rotation of shafts 306, 306′, for example in the direction of arrow 337, causes rotation of lower rollers 108b, 108b′ in the same direction. Nipping of the web 12 between lower rollers 108b, 108b′ and corresponding upper rollers 108a, 108a′, in turn, results in movement of the web 12 in the machine direction (arrow 15).

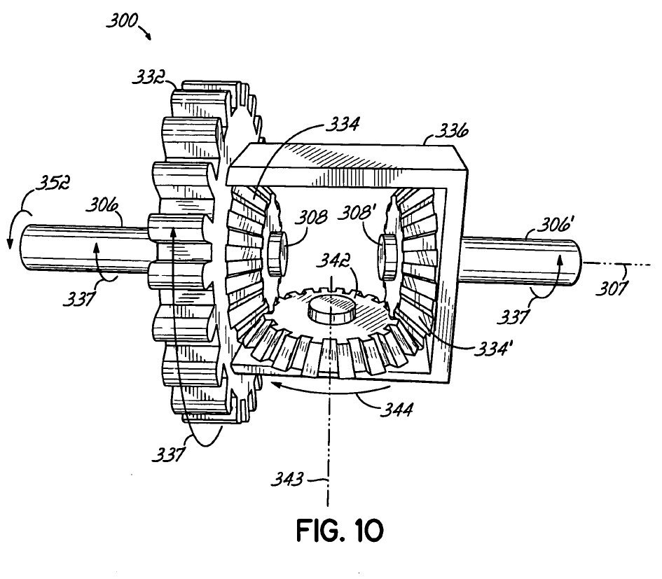

To this end, and with particular reference to FIG. 10, web driving apparatus 106 supplies torque to a ring gear 332 of differential 300. Ring gear 332 is rotationally coupled to respective shaft gears 334, 334′ at proximal ends 308, 308′ of shafts 306, 306′ through a carrier 336. Rotation of ring gear 332, for example, in the direction of arrows 337, rotates carrier 336 and thereby shaft gears 334, 334′ also in the direction of arrows 337. This rotation of shaft gears 334, 334′, in turn, causes simultaneous rotation of shafts 306, 306′, in the same direction, at substantially equal angular speeds and resulting in about equal surface speeds of rotation of lower rollers 108b, 108b′. As used herein, the term “surface speed” refers to the speed of the circumferential surface of the rollers 108a, 108a′, 108b, 108b′, and more particularly, at the interface of these circumferential surfaces with the web 12.

Rotation of ring gear 332 induces rotation of a pinion gear 342 supported by carrier 336, with this rotation being about axis 307 of shafts 306, 306′, and in the direction of arrows 337. Pinion gear 342 is rotatable about a pinion gear axis 343 that is generally orthogonal to axis 307. Notably, pinion gear 342 is intermeshed with both of the shaft gears 334, 334′ such that rotation of pinion gear 342 about axis 343 results in rotation of shaft gears 334, 334′ relative to one another. Indirect coupling of the shafts 306, 306′ to one another through pinion gear 342 permits rotation of shafts 306, 306′ relative to one another and thus rotation of lower rollers 108b, 108b′ relative to one another. Accordingly, in operation, this coupling permits lower roller 108b to rotate at a surface speed that is different (e.g., greater or less than) from a surface speed associated with lower roller 108b′.

In operation, the ability of lower rollers 108b, 108b′ to rotate at surface speeds different from one another permits correction of skewing in the travel of web 12 in the machine direction (arrow 15). An exemplary scenario illustrates this feature. Torque is supplied to the ring gear 332 to cause it to rotate at a nominal angular velocity “ω.” This rotation results in rotation, in the direction of arrows 337, of shafts 306, 306′, and thus, corresponding rotation of lower rollers 108b, 108b′ at the same angular velocity and at substantially equal surface speeds relative to one another. In this scenario, no skewing of the web 12 during travel in the machine direction (arrow 15) occurs and pinion gear 342 does not rotate about axis 343. Accordingly, web 12 moves in the machine direction at a nominal speed “s,” which is also the nominal surface speed of lower rollers 108b, 108b′.

In an exemplary skewing event, the left side of the web 12 (with reference to the orientation of FIG. 9) moves faster than nominal speed “s,” thus resulting in skewing of the web 12 to the right. This skewing generates a tendency on the right side of the web 12 to speed up to resume travel of the web in the machine direction (arrow 15) i.e., a direction normal to the axis 307 of rotation of lower rollers 108b, 108b′. This tendency results in the lower roller 108b′ on the right side of the web 12 to rotate at a surface speed greater than “s” and therefore causes shaft 306′ and shaft gear 334′ to rotate at an angular velocity greater than “ω.” This relatively higher angular velocity of shaft gear 334′ causes pinion gear 342 to rotate in the direction of arrow 344 about axis 343, which, in turn, results in shaft gear 334 (on the left side of the web) rotating in the opposite direction (arrow 352). This relative rotation of shaft gear 334 in the opposite direction (arrow 352), in turn, results in lower roller 108b rotating in the opposite direction relative to the rotation of lower roller 108b′ associated with the right side of the web 12. Accordingly, this relative opposite direction rotation of lower roller 108b on the left side of the web has the net effect of slowing lower roller 108b to thus attain a lower surface speed, until it reaches equilibrium at surface speed “s.” Thus, the differential 300 provides a self-corrective feature that aids in guiding web 12 as it travels, in the machine direction, through cutting module 30.

While the guiding apparatus defined by web driving apparatus 106 is herein shown in the context of a cutting module, it is contemplated that such guiding apparatus and/or the process it entails are similarly useful for other processes where guidance of a web of paper or film is desired. Likewise, while the exemplary differential 300 is described having gears as discussed above, it is contemplated that other arrangements of gears or similar components may be used, so long as they provide the self-corrective feature described herein.

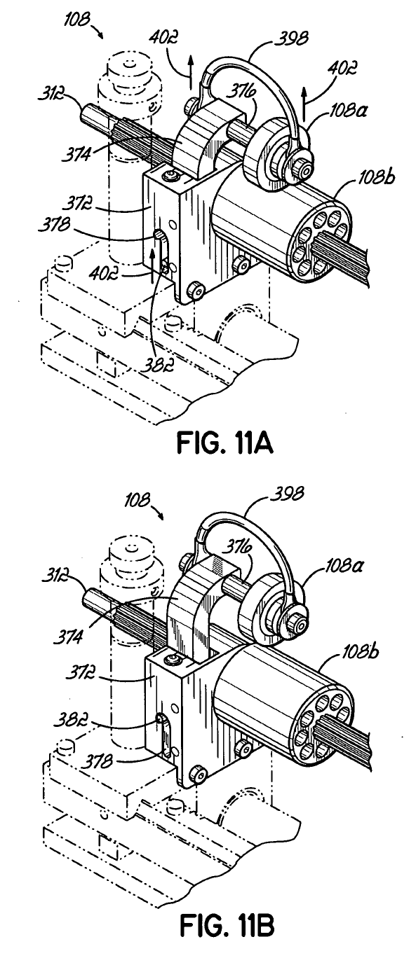

As discussed above, roller assemblies 108, 108′ include upper rollers 108a, 108a′. With particular reference to FIGS. 11A-11B, details of the exemplary roller assembly 108 are illustrated. Upper roller 108a cooperates with corresponding lower roller 108b to nip the web 12 (FIG. 9) as it travels in the machine direction. Notably, in this embodiment, upper roller 108a is configured to facilitate engagement with and disengagement from the web 12. More particularly, upper roller 108a is slidingly coupled within a support block 372 that supports the lower roller 108b such that upper roller 108a can be moved toward and away from lower roller 108b. To this end, a leg 374 supports a shaft 376 of upper roller 108a and is movable along a generally J-shaped channel 378 of support block 372. More specifically, a pin 382 coupled to leg 374 is held within the channel 378 and movable therein between a first position (FIG. 11A) associated with a state of engagement with the web 12 and a second position (FIG. 11B) associated with disengagement from web 12.

The position of engagement of upper roller 108a with web 12 is associated with a bottom-most position of pin 382 at the base of the channel 378. The position of disengagement of upper roller 108a with web 12 is associated with the upper end of the channel 378. Notably, and as best illustrated by FIG. 11B, the orientation and shape of the upper end of channel 378 provides a resting position for upper roller 108a in the disengagement position.

In one aspect of the embodiment of FIGS. 11A-11B, a chord 398 facilitates lifting of leg 374 and thereby upper roller 108a away from lower roller 108b, in the general direction of arrows 402. Chord 398 is secured to the ends of shaft 376 of upper roller 108a. The lifting action facilitated by chord 398 also moves pin 382 in the direction of arrows 402. Although not shown, this lifting action further includes movement of leg 374 and, more particularly, pin 382 laterally to the resting position (described above) within channel 378.

Those of ordinary skill in the art will appreciate that the type of coupling between upper and lower roller 108a, 108b is not limited to the above description but it could alternatively or additionally take on any suitably chosen components and/or configurations. For example, and without limitation, upper roller 108a may be instead pivotally coupled relative to lower roller 108b. Alternatively also, both of the upper and lower rollers 108a, 108b may be movable toward and away from one another.

While the present invention has been illustrated by a description of various embodiments and while these embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of the general inventive concept.

What is claimed is:

1. A cutting apparatus for transversely cutting a web of paper or film traveling: in a machine direction, comprising:
a main body;
a first blade coupled to a distal end of said main body and having an edge for transversely cutting the web; and
a blade driving apparatus coupled to said main body for controlling reciprocating motion of said first blade toward and away from the web;
wherein said main body is substantially made of a material having a lower density relative to said first blade.

2. The apparatus of claim 1, wherein said first blade is releasably coupled to said main body to permit replacement thereof.

3. The apparatus of claim 1, wherein said first blade includes steel.

4. The apparatus of claim 1, wherein said main body is substantially made of carbon fiber.

5. The apparatus of claim 1, wherein movement of said first blade toward the web includes movement thereof from a home position where said blade is fully disengaged from the web to a second position where said blade is fully engaged with the web, said driving apparatus being configured to selectively stop movement of said blade before said blade reaches the second position.

6. The apparatus of claim 1, wherein each reciprocating motion of said first blade from a home position and back to said home position defines a cutting cycle, said blade driving apparatus being configured to drive said first blade at a rate of about 60,000 cycles per hour.

7. The apparatus of claim 1, wherein said blade driving apparatus includes a motor and at least one rod operatively coupled thereto, said rod being coupled to said main body to drive said first blade in reciprocating motion.

8. The apparatus of claim 1, further comprising:
a web driving apparatus for driving the web in the machine direction and cooperating with said blade driving apparatus to selectively stop the web at a predetermined position before said first blade cuts the web.

9. The apparatus of claim 8, wherein the web has a slit extending generally along the machine direction thereby defining first and second lateral portions of the web, said driving apparatus cooperating with said blade driving apparatus to move the first lateral portion in the machine direction while holding the second lateral portion stationary relative to said first lateral portion.

10. The apparatus of claim 1, wherein said first blade is angled in a direction transverse to the machine direction.

11. The apparatus of claim 1, further comprising:
a second blade disposed opposite said first blade and cooperating with said first blade to effect a shear cut on the web.

12. The apparatus of claim 11, wherein said second blade is stationary.

13. The apparatus of claim 1, wherein said first blade includes first and second cutting edges for respectively effecting first and second transverse cuts of the web spaced in the machine direction.

14. A cutting apparatus for cutting a web of paper or film traveling in a machine direction, comprising:
a support frame;
a web driving apparatus for moving the web in the machine direction;
at least one slitting blade supported in the support frame for slitting the web in the machine direction to thereby define at least first and second lateral portions of the web;
a cutting apparatus operatively coupled to said web driving apparatus for cutting the web in a direction transverse to the machine direction and including a main body and a first blade coupled thereto, said main body substantially made of a material having a lower density relative to said main body; and
a cutting apparatus driving apparatus coupled to said main body for controlling reciprocating motion of said first blade toward and away from the web.

15. The apparatus of claim 14, wherein said first blade includes first and second cutting edges for respectively effecting first and second transverse cuts of the web spaced in the machine direction.

16. The apparatus of claim 14, further comprising:
at least one edge slitting apparatus configured to engage a lateral edge of the web for trimming of the web.

17. The apparatus of claim 14, wherein said web driving apparatus includes a brake movable toward and away from the web, movement thereof toward the web configured to disrupt travel of the web in the machine direction associated with transverse cutting of the web by said cutting apparatus.

18. The apparatus of claim 17, wherein said brake includes a brush coupled thereto for engaging the web.

19. The apparatus of claim 17, wherein said web driving apparatus is configured to move said brake away from the web during acceleration thereof in the machine direction.

20. The apparatus of claim 14, wherein said brake is oriented at an acute angle relative to a plane of travel of the web in the machine direction.

21. The apparatus of claim 14, wherein said first blade is angled in a direction transverse to the machine direction.

22. An automatic envelope stuffing machine, comprising:
a first end associated with feeding of a roll of paper in a machine direction;
a second end associated with feeding of envelopes toward the discrete paper objects; and
a cutting apparatus for transversely cutting the roll of paper including:
(a) a main body;
(b) a first blade coupled to a distal end of said main body and having an edge for transversely cutting the web; and
(c) a blade driving apparatus coupled to said main body for controlling reciprocating motion of said first blade toward and away from the web;
wherein said main body is substantially made of a material having a lower density relative to said first blade.

23. A cutting apparatus for transversely cutting a web of paper or film traveling in a machine direction, comprising:
a cutting apparatus including a main body and a first blade coupled to a distal end of said main body and having an edge for transversely cutting the web, said main body being substantially made of a material having a lower density relative to said first blade;
a blade driving apparatus coupled to said main body for controlling reciprocating motion of said first blade toward and away from the web; and
a guiding apparatus for guiding the web toward the cutting apparatus, said guiding apparatus including a web driving apparatus and first and second rollers disposed along an axis generally orthogonal to the machine direction and configured for respectively engaging first and second lateral edges of the web, said driving apparatus being configured to permit said first and second rollers to rotate at respective first and second surface speeds relative to one another.

24. A method of guiding a web of paper or film traveling in a machine direction, the web having opposed first and second lateral edges, the method comprising:
engaging the first and second lateral edges respectively with first and second rollers disposed along an axis generally orthogonal to the machine direction;
rotating the first and second rollers to thereby move the web in the machine direction; and
allowing the first roller to rotate at a first surface speed different from a second surface speed associated with the second roller.

25. The method of claim 24, further comprising:
rotating the first and second rollers from a common driver coupled to the first and second rollers.

26. The method of claim 24, further comprising:
speeding up the first roller in response to skewing of the web; and
slowing down the second roller in response to the speeding of the first roller to thereby correct the skewing of the web.

27. The method of claim 24, wherein engaging the first and second lateral edges includes frictionally engaging the first and second lateral edges respectively with the first and second rollers.

28. The method of claim 24, further comprising:
rotating the first and second rollers from a differential coupled to the first and second rollers.

29. The method of claim 24, wherein engaging the first and second lateral edges includes engaging the first and second lateral edges with respective third and fourth rollers respectively cooperating with the first and second rollers to thereby nip the lateral edges of the web.

30. The method of claim 29, further comprising:
sliding at least one of the third or fourth rollers to engage the lateral edges of the web.

31. The method of claim 24, further comprising:
rotating the first roller in a first direction and rotating the second roller in a second direction different from the first direction.

32. The method of claim 31, wherein rotating the first roller in the first direction causes the second roller to rotate in the second direction.

33. An apparatus for guiding a web of paper or film traveling in a machine direction, comprising:
first and second rollers disposed along an axis generally orthogonal to the machine direction and configured for respectively engaging first and second opposed lateral edges of the web; and
a driving apparatus coupled to said first and second rollers for rotating said first and second rollers, rotation of said first and second rollers being configured to move the web in the machine direction;
wherein said driving apparatus is configured to permit said first and second rollers to rotate at respective first and second surface speeds different from one another.

34. The apparatus of claim 33, wherein said driving apparatus includes a differential.

35. The apparatus of claim 33, wherein said first and second rollers are configured to frictionally engage the web.

36. The apparatus of claim 33, further comprising:
third and fourth rollers respectively cooperating with said first and second rollers to nip the lateral edges of the web.

37. The apparatus of claim 36, wherein at least one of said third or fourth rollers is slidably movable respectively away from a corresponding one of said first or second rollers to permit disengagement of said at least one of said third or fourth rollers from the web.

38. The apparatus of claim 33, wherein said driving apparatus is disposed between said first and second rollers.

39. The apparatus of claim 33, wherein coupling between said driving apparatus and said first roller is such that said first roller can be made to rotate at the first surface speed by action of the web.

40. The apparatus of claim 33, wherein said driving apparatus includes a generally flat surface for supporting a portion of the web.

41. An apparatus for guiding a web of paper or film traveling in a machine direction, comprising:
first and second rollers disposed along an axis generally orthogonal to the machine direction and configured for respectively engaging first and second opposed lateral edges of the web; and
a differential disposed between said first and second rollers and coupled thereto for rotating said first and second rollers, rotation of said first and second rollers being configured to move the web in the machine direction; and
third and fourth rollers respectively cooperating with said first and second rollers to nip the lateral edges of the web;
wherein said differential is configured to permit the web to cause said first and second rollers to rotate at respective first and second surface speeds different from one another.

42. A method of cutting a web of paper or film traveling in a machine direction, the method comprising:
moving the web in the machine direction;
moving a leading portion of the web past a cutting apparatus;
stopping travel of the web in the machine direction;
slitting the leading portion of the web generally along the machine direction prior to moving the leading portion past the cutting apparatus, the slitting defining at least first and second lateral portions of the web; and
cutting the first lateral portion of the web while holding the second lateral portion stationary and uncut relative to the first lateral portion.

43. The method of claim 42, further comprising:
engaging the first and second lateral edges of the web respectively with first and second rollers disposed along an axis generally orthogonal to the machine direction;
rotating the first and second rollers to thereby move the web in the machine direction; and
allowing the first roller to rotate at a first surface speed different from a second surface speed associated with the second roller in response to skewing of the web.
